(19) United States
(12) Patent Application Publication
(10) Pub. No.: US 2019/0012681 A1
(43) Pub. Date: Jan. 10, 2019

(54) DETERMINING VIEWABILITY OF CONTENT ITEMS DISPLAYED ON CLIENT DEVICES BASED ON USER INTERACTIONS

(71) Applicant: Facebook, Inc., Menlo Park, CA (US)

(72) Inventors: Luxi Guo, Bellevue, WA (US); Aleksey Sergeyevich Fadeev, Seattle, WA (US); Liang Xu, Bellevue, WA (US)

(21) Appl. No.: 15/645,184

(22) Filed: Jul. 10, 2017

(51) Int. Cl. G06Q 30/02; G06Q 10/06

(52) U.S. Cl. CPC G06Q 30/0202; G06Q 30/0246; G06Q 10/067

(57) ABSTRACT

An online system predicts viewability of content items based on user interactions associated with the content items. The online system sends content items for display via client devices. The online system receives a request for a report based on viewability of the content item. The online system receives user interactions with the content item and determines a value of a user interaction metric based on the received user interactions. The online system provides the value of the user interaction metric as input to a correlation model to predict a value of the viewability metric for the content items. The online system may generates report based on the predicted viewability metric value.

### BACKGROUND

This disclosure relates generally to distribution and presentation of content items by an online system, and more specifically to viewability of content items sent by the online system for display via client devices.

Some online systems like social networking systems send content items such as images and text for display via client devices. Online systems may receive content items from content providers. Content providers are interested in knowing whether the online content items were viewed by users. Even if a client device presents the content item a user may not get an opportunity to view the content item. For example, the content item may be hidden under another window presented by the client device. As another example, the content item may be displayed for a very short amount of time, for example, as the user scrolls through a window displaying the content item. As a result, the user may never get an opportunity properly view the content item. Content providers or content publishers are interested in knowing whether the content item was viewed by the user. A client device may provide signals indicating a likelihood of a user viewing a content item presented by the client device. However, client devices often do not provide such signal, for example, due to errors in the code generating the signals or due to lack of proper instructions in web pages for providing such signals. As a result, reports describing whether content items were viewed by users are often inadequate.

### BRIEF DESCRIPTION OF THE FIGURES

FIG. 1 shows a block diagram of a system environment of an online system, according to one embodiment.

FIG. 2 shows a block diagram illustrating the system architecture of the online system shown in FIG. 1, according to one embodiment.

FIG. 3A-3B show an example of viewability of an online content item 320, according to one embodiment.

FIG. 4 shows an example flowchart illustrating a process of generating a correlation model, according to one embodiment.

FIG. 5 shows an example flowchart illustrating a process of applying the correlation model to predict viewability of online content, according to one embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality

### SUMMARY

Embodiments determine viewability of content items sent by an online system for display via client devices. Viewability is a metric indicating a likelihood that a content item displayed on a client device was actually viewed by the user. For example, if a content item was presented for a very short interval of time on a display screen of the client device, the viewability of the content item is low. Similarly, if a very small portion of the content item, such as an image is shown on a display screen, the viewability of the content item is low.

The online system receives a request for a report based on viewability of a content item. The online system predicts viewability of the content item based on user interactions if sufficient viewability signals are not received from the client devices. Accordingly, the online system receives user interactions with the content item and determines a value of a user interaction metric based on the received user interactions. For example, the user interaction metric may represent a click through rate (CTR). The online system provides the value of the user interaction metric as input to a correlation model configured to predict the value of the viewability metric based on the user interaction metric. The online system obtains the predicted value of the viewability metric using the correlation model and generates the requested report based on the predicted viewability metric value.

According to an embodiment, the correlation model is provider level and predicts viewability of content items from a particular content provider. Accordingly, if viewability signal is not available for a particular content item of the content provider, the online system uses the provider level correlation model to predict the viewability for the content item.

According to another embodiment, the correlation model is placement level and predicts viewability of content items having a particular placement on a user interface presented by a client device. Accordingly, if viewability signal is not available for a particular content item having a particular placement, the online system uses the placement level correlation model to predict the viewability for the content item.

### DETAILED DESCRIPTION OF THE FIGURES

Viewability of a content item measures a likelihood that a content item displayed on a client device was actually viewed by the user. A content item displayed on a client device may not be seen by a user for several reasons. For example, client devices may display multiple windows and a content item presented via a window of one client application may get hidden under a window of another application. Alternatively high scroll speed may cause the content item to not be visible on the display screen long enough to allow a user to view the content item. As a result, even though the online system sends the content item for display via a client device and the client device presents the content item, in practice the content item may not be viewed by any user.

Reports that are based on a number of times the content item was displayed by client devices are inaccurate or ineffective since they are based on the number of times a content item was displayed on a client device but do not account for situations when the user never saw the content item. Use of viewability signals allows the reports to be accurate, thereby accounting for instances when the content item was displayed but was unlikely to have been seen by the user. However, viewability signals may not always be available from all client devices or from all client applications or from all content items. Viewability signals may not be available due to errors in the code providing the viewability signals or lack of the code that provides the viewability signal in a web page. Embodiments of the invention allow the viewability signals to be predicted from user interactions that are more readily available.

### Overall System Environment

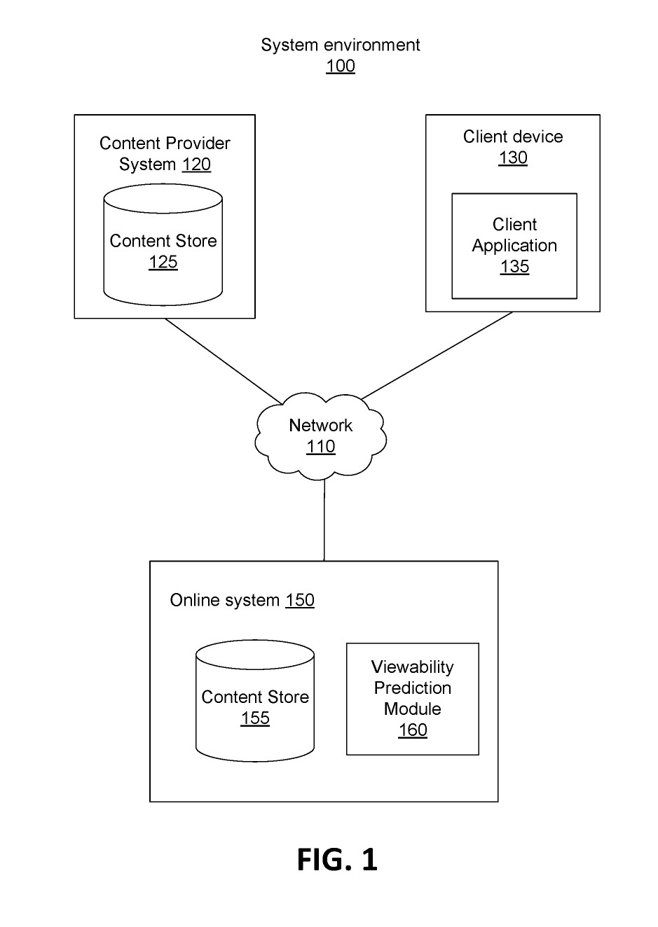

FIG. 1 shows a block diagram of a system environment 100 in which an online system 150 operates, according to one embodiment. The system environment 100 comprises one or more content provider systems 120, one or more client devices 130, a network 110, and the online system 150. For purpose of illustration, FIG. 1 shows only one content provider system 120, one client device 130, and one online system 150. In alternative configurations, there can be multiple content provider systems 120, multiple client devices 130, and multiple online systems 150. Likewise, different and/or additional components may be included in the system environment 100.

The content provider system 120 provides content items to the online system 150 and/or the client device 130. A content item may also be referred to herein as a content or an online content item. The content provider system 120 includes a content store 125 that stores content items. Content items may comprise one or more of text, image, video, audio, and so on. The content provider system 120 provides content items to the online system 150 via the network 110. In some embodiments, the online system 150 receives content items from users of the online system 150. In some embodiments, a content item is a sponsored content item for which a content provider provides remuneration to the online system for presenting the content item to users. Examples of sponsored content items include advertisements.

The client device 130 is a computing device capable of receiving user input as well as transmitting and/or receiving data via the network 110. In one embodiment, a client device 130 is a conventional computer system, such as a desktop or a laptop computer. Alternatively, a client device 130 may be a device having computer functionality, such as a personal digital assistant (PDA), a mobile telephone, a smartphone, or another suitable device. A client device 130 is configured to communicate via the network 110.

As shown in FIG. 1, the client device 130 executes a client application 135 allowing a user of the client device 130 to interact with the online system 150 via the network 110. For example, a client device 130 executes a client application 135 to enable interaction between the client device 130 and the online system 150 via the network 110. An example of a client application 130 is a browser application, for example, an internet browser application that receives web pages from the online system 150 and presents user interfaces based on the web pages.

In another embodiment not shown, a client device 130 interacts with the online system 150 through an application programming interface (API) running on a native operating system of the client device 130, such as IOS® or ANDROID™. The client device 130 is configured to communicate via the network 110, which may comprise any combination of local area and/or wide area networks, using both wired and/or wireless communication systems.

In one embodiment, the network 110 uses standard communications technologies and/or protocols. For example, the network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any suitable format, such as hypertext markup language (HTML) or extensible markup language (XML). In some embodiments, all or some of the communication links of the network 110 may be encrypted using any suitable technique or techniques.

The online system 150 interacts with the content provider system 120 as well as the client device 130 via the network 110. The online system 150 requests and receives online content items from the content provider system 120 and stores the received content items in the content store 155. The online system 150 also sends content items to client device 130 for display to the user of the client device. The online system 150 also receives other information from the client device 130 such as user interaction data (e.g., clicks performed by users) and/or viewability signal associated with the specific content items. The online system 150 uses information describing user interactions to determine user interaction metrics, for example, click through rate. The online system 150 receives requests from the client device 130 for reports based on viewability signal of specific content items displayed on the client device 130.

The online system 150 sends one or more content items to the client device 130 for presenting to a user of the client device 130. The content items are presented via client application 135 executing on the client device 130. The client application 130 may have certain placements of the content items. For example, a content item may be presented in a side bar according to a particular placement or in the body of a web page according to another placement.

Certain content items may be presented via the client application 135 in a manner that results in a very low likelihood that the user actually views the content item. For example, even though the content item is presented via the client application 135, only a small portion of the content item is visible via a display screen of the client device 130 while the remaining content item is placed outside the visible area of the display screen or is hidden under another window and is therefore never shown by the client device. As a result, the client device 130 may determine that the likelihood user saw the content item is low.

Similarly, the client device may present the content item on the display screen of the client device for a very short time interval that has a length below a threshold value. For example, a user may be scrolling at a high scroll rate through a web page and a content item presented via the web page may be displayed on the display screen of the client device 130 for a very short time interval. As a result, the user is unlikely to have viewed the content item.

The client application 135 executes script code, for example, JAVASCRIPT code that determines a metric indicating the viewability of a content item. The metric is referred to herein as viewability metric. The viewability metric indicates a likelihood that a user viewed the content item when the content item was presented via the client application 135. The client application 135 determines the viewability metric based on one or more of a size or amount of the portion of the content item presented via the client device 130 and the length of time interval for which the content item was presented via the client device 130. The client application 135 sends the viewability metric value to the online system 150 for each impression of the content item, wherein an impression represents an instance of presentation of the content item via the client application 135.

In certain situations, the client application 135 may not send the viewability metric to the online system 150 for each impression of a content item. This may happen due to defects in the script code that determines the viewability metric and sends the viewability metric value to the online system 150. Alternatively, the client application 135 may not send viewability signal if it does not have the code or instructions for determining the viewability signal. For example, a web page received by the client application from a web site may not include the instructions for determining and sending the viewability metric to the online system. Accordingly, the online system 150 may receive viewability metric from certain devices but not from other devices. Alternatively, the online system 150 may receive viewability metric from some types of client applications 135 but not from others.

The viewability can be measured using viewability metric in different ways. As one example, with a binary measurement metric, the content item being viewed by the user makes the value of the metric “1”, and in contrast, the content item not being viewed by the user makes the value of the metric “0”. As another example, with a continuous measurement metric, given percentage of the content item being viewed and the period of time that percentage of the content item being viewed, the value of the viewability metric can range from 0% to 100%.

The online system 150 also receives data indicating user interactions with content items from the client devices. For example, a signal may indicate that a user clicked on a content item to view the content item, the user shared the content item with other users, the user recommended the content item to other users, the user commented on the content item, or the user liked the content item, and so on. The online system 150 receives user interaction data and determines one or more user interaction metrics based on the user interaction data. For example, a user interaction metric may represent a rate of performing a specific type of user interaction.

In an embodiment, a client device 130 sends a request for a report based on viewability of specific content items. The online system 150 generates the report based on viewability signals received from various client devices and sends to the requesting client device 130. The online system 150 predicts viewability signal of specific content items received and displayed on the client device 130 while the viewability signal is not available. The online system 150 generates the requested report based on the predicted values of viewability metrics when the viewability signal is not available.

Further details of embodiments for predicting viewability metric are described below with reference to various figures.

### System Architecture

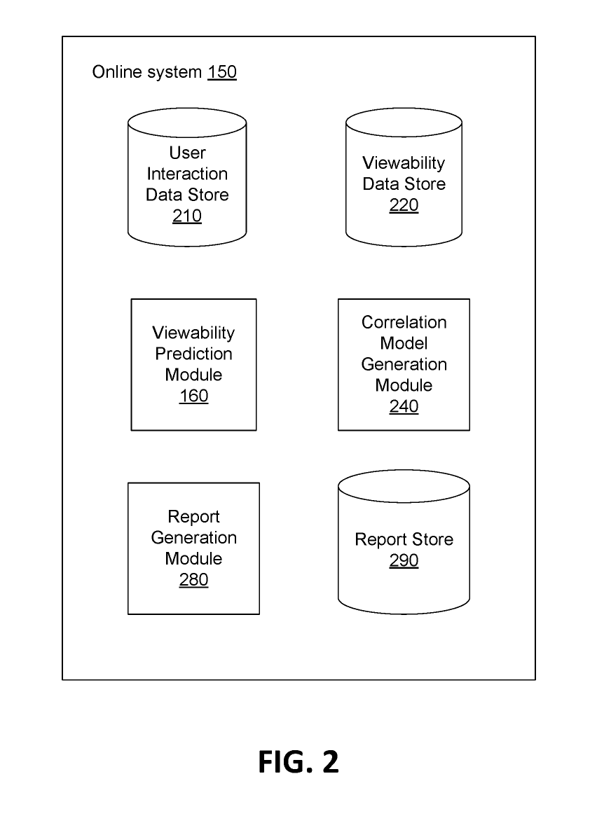

FIG. 2 shows a block diagram illustrating the system architecture of the online system 150 shown in FIG. 1, according to one embodiment. The online system 150 shown in FIG. 2 includes a user interaction data store 210, a viewability data store 220, a user interaction data store 230, a correlation model generation module 240, a viewability prediction module 160, a report generation module 280, and a report store 290. Other embodiments may include more or fewer modules. Actions indicated as performed by a particular module may be performed by other modules than those indicated herein.

The viewability data store 220 stores information describing viewability signals associated with content items. The online system 150 receives viewability signals from client devices 130 and stores the information received in the viewability data store 220. In an embodiment, the viewability data store 220 stores the viewability signals as a table storing records that include an identifier for a content item, an identifier for a client device on which the content item was shown, a timestamp value associated with the presentation of the content item, and a value of the viewability signal information for that particular instance of presentation of the content item.

The user interaction data store 210 stores information describing user interactions with the content items, for example, a user interaction metric associated with each content item. An example of a user interaction metric is a click through rate (CTR) data associated with the content items. In an embodiment, the user interaction metric comprises a measure of a rate at which users interact with a content item responsive to being presented with the content item. For example, the user interaction metric may represent a number of times users interacted on the content item out of a given number of impressions or instances of presentation of the content item via client devices.

The users may interact with the content item to perform various actions, for example, to view a content item, to access additional information associated with the content item, to access a uniform resource locator (URL) associated with the content item, to share the content item, to comment on the content item, to like the content item, and so on. In an embodiment, the user interaction metric may represent an aggregate rate of a particular type of user interactions. For example, the user interaction metric may aggregate only the rate at which users access the content item and ignore other user interactions. In other embodiments, the user interaction metric may represent an aggregate rate of a plurality of different type of user interactions. In an embodiment, the user interaction metric may represent an aggregate rate of user interactions that weighs certain user interactions higher than other user interactions.

The correlation model generation module 240 of the online system 150 uses the data stored in the user interaction data store 210 and in the viewability data store 220 to generate a correlation model. The correlation model predicts viewability metric values for a content item from input user interaction metric values. The correlation model generation module 240 receives online data associated with content items with known viewability signals. Accordingly, the correlation model generation module 240 receives user interaction data from the user interaction data store 210 and viewability signal data from the viewability data store 220. The correlation model generation module 240 determines a relation between user interactions and viewability associated with content items.

The viewability prediction module 160 predicts viewability signal associated with target content items. In more detail, the viewability prediction module 160 receives the correlation model generated by the correlation model generation module 240, and the user interaction data associated with target content items from the user interaction data store 230. The viewability prediction module 160 predicts, e.g., determines viewability metric value for a target content item using the correlation model and the user interaction metric value. The viewability prediction module 160 stores the predicted viewability metric values for target content items in the predicted viewability data store 270.

In an embodiment, the correlation model is a function that maps user interaction metric to viewability metric. For example, the correlation model may be a polynomial function, such as a linear function, quadratic function, or a higher order polynomial function. The correlation model generation module 240 determines coefficient values for the polynomial function based on data comprising known viewability metric values and user interaction metric values.

In an embodiment, the correlation model generation module 240 uses curve fitting techniques, for example least squares curve fitting, general curve fitting or other techniques for determining a function that maps the user interaction metric to viewability metric for one or more content items. For example, the correlation model generation module 240 may identify data points comprising pairs of values of the user interaction metric and the corresponding viewability metric. The correlation model generation module 240 fits a curve through the determined data points and uses the curve for predicting viewability metric for input user interaction metric values.

In an embodiment, the correlation model is represented as a mapping table that maps user interaction metric values to viewability metric values. The correlation model may map ranges of user interaction metric values to specific viewability metric values. Alternatively, the correlation model may map specific user interaction metric values to specific viewability metric values and the viewability prediction module 160 uses interpolation techniques to determine a value of a viewability metric for an input user interaction metric that is not mapped by the mapping table.

In an embodiment, for each content item out of a plurality of content items, the correlation model generation module 240 determines the correlation between the user interaction metric and viewability metric associated with the content item. After receiving online data associated with a threshold number of content items with known viewability, the correlation model generation module 240 generates a correlation model between user interaction metrics and viewability metrics that applies to a plurality of content items. For example, the correlation model generation module 240 may generate a correlation model applicable to all content items from a particular content provider. As another example, the correlation model generation module 240 may generate a correlation model applicable to all content items associated with a particular placement of the content items in the client application 135. Alternatively, the correlation model generation module 240 may generate a correlation model applicable to a specific content item or to a subset of content items from a content provider, for example, one or more content items representing a campaign of the content provider. A campaign of the content provider may present one or more related content items to users for a particular period of time.

The correlation model generation module 240 may also generate one combined correlation model suitable for multiple criteria such as both provider level and placement level. For example, a correlation model may be applicable to all content items of one or more content providers for a specific placement of content.

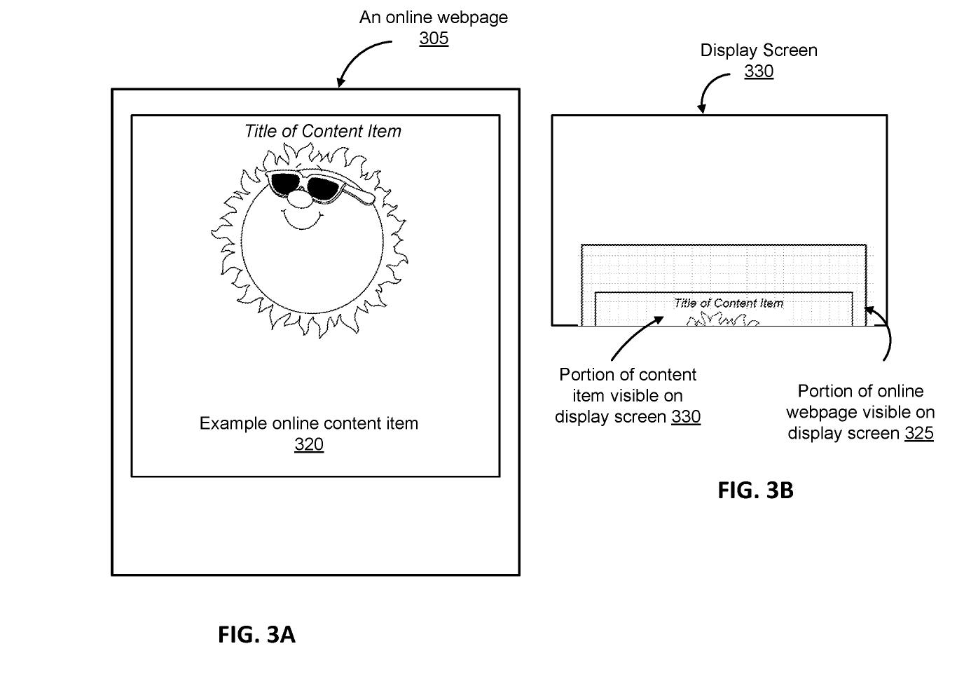

FIG. 3A-3B show an example of viewability of an online content item 320, according to one embodiment. As shown in FIG. 3A, a content item 320 showing an image of a cartoon sun is displayed on an online webpage 305. FIG. 3A shows the web page 305 as it would appear if the entire web page can be displayed on the screen of a client device. FIG. 3B shows how the online web page 305 may appear on the display screen 330 of a client device. As shown in FIG. 3B, only a portion 325 of the online web page is visible on the display screen 330 and accordingly a portion 330 of the content item 320 is displayed on the display screen 330.

If the portion 325 of the content item 320 shown on the display screen of the client device 130 is below a threshold percentage value of the overall content item, the client device 130 may send a viewability metric indicating that the likelihood that the user viewed the content item is low. In some embodiment, even if the entire content item 320 is shown on the displayed on the display screen 330, the client device 130 may report low value of viewability metric if the content item 320 is presented for less than a threshold amount of time.

### Overall Process

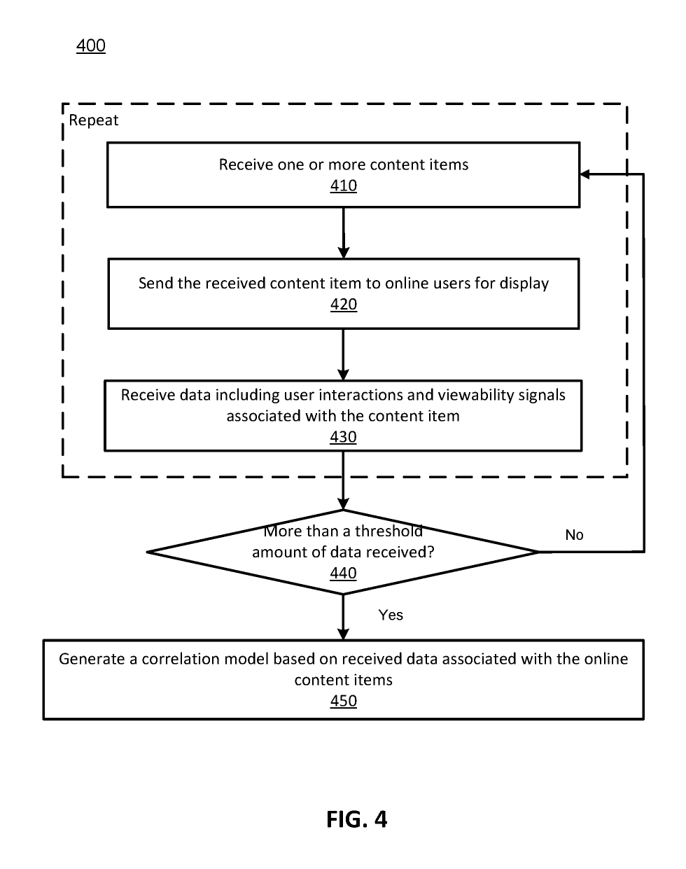

FIG. 4 shows an example flowchart 400 illustrating a process of generating a correlation model by the online system 150, according to one embodiment. In FIG. 4, the online system 150 receives 410 one or more content items, and sends 420 the received content items to client devices of online users for display. The online system 150 receives 430 data including user interactions and viewability signals associated with the content item. The online system 150 repeats the process of step 410, 420 and 430 until more than a threshold amount data is received 440.

The correlation model generation module 240 may receive information identifying the type of correlation model to generate, for example, provider level or placement level. If the online system 150 receives instructions to generate a provider level correlation model for a specific content provider, the online system 150 collects user interaction data and viewability signals for content items associated with that specific content provider.

If the online system 150 receives instructions to generate a placement level correlation model for a specific placement, the online system 150 collects user interaction data and viewability signals for content items presented via that specific placement, even if they are provided by different content providers. The online system 150 generates 450 a correlation model based on the received data associated with the one or more content items.

In other embodiments, the online system 150 receives specific criteria describing the type of correlation model to generate, for example, one or more content providers and one or more placements, or correlation model for a specific campaign of a content provider. The online system 150 generates 450 a correlation model based on the specific criteria using the received data.

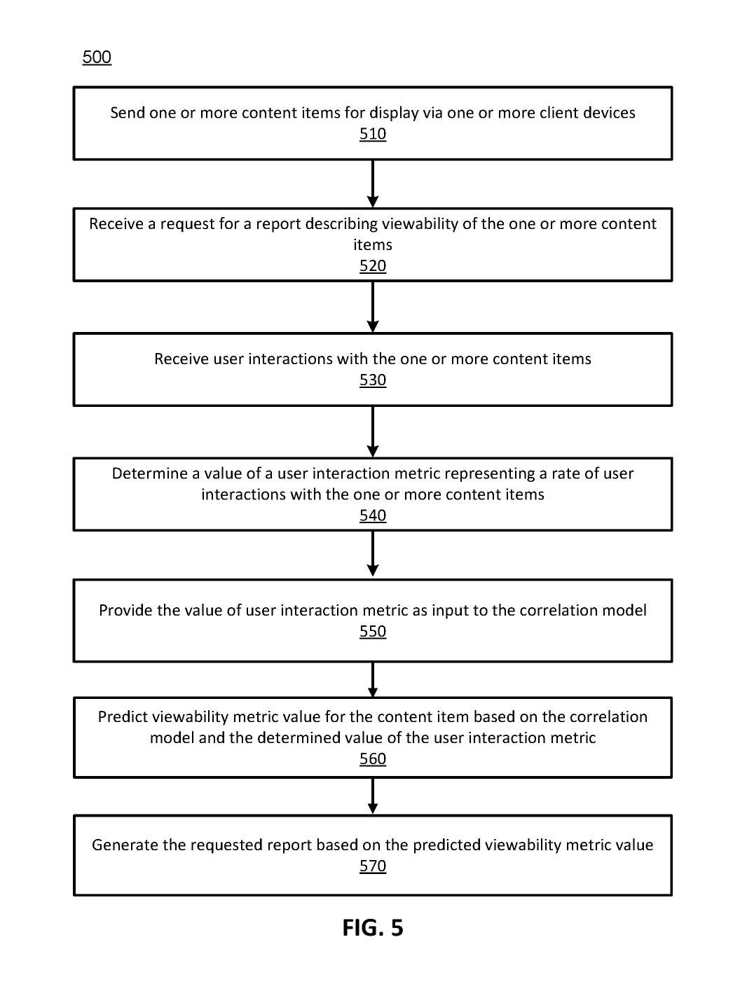

FIG. 5 shows an example flowchart 500 illustrating a process of applying the correlation model to predict viewability of target content items by the online system 150, according to one embodiment. In FIG. 5, the online system 150 sends 510 a content item for display to one or more users. The online system 150 determines that viewability signals for the instances of presentation of the content item is not received from one or more client devices to which the content item is sent for presentation. The client devices may not send the viewability signal due to failure of the script code executing on the client device for generating and sending the viewability signal or for other reasons.

The online system 150 receives 520 a request for a report describing viewability of the content item. The online system 150 receives user interactions with the content item performed via one or more client devices. The online system 150 determines 540 a value of the user interaction metric representing rate of user interactions with the content item. The online system 150 provides 550 the value of user interaction metric as input to the correlation model generated in FIG. 4. The online system 150 predicts 560 viewability metric value for the content item based on the correlation model and the determined value of the user interaction metric. The online system 150 generates 570 the requested report based on the predicted viewability metric value.

In some embodiments, the viewability signal may be available from some types of client devices or client applications and not available from other types of client devices or client applications. In this embodiment, the online system 150 predicts 560 viewability metric value for client devices or client applications that do not provide the viewability signal and combines the predicted values with viewability signals for client devices that provide the viewability signals. The online system 150 aggregates the metric values based on known viewability signals and predicted viewability metrics. For example, the online system 150 generates a first partial result of viewability metric for client devices that provide the viewability signals based on the provided viewability signals. The generates a second partial result of viewability metric for client devices that did not provide the viewability signals by using the correlation model and user interaction metrics based on user interactions from those client devices. The online system 150 combines the first partial result and the second partial result to determine the overall viewability metric value.

In an embodiment, the online system 150 generates and stores correlation models for various categories of content providers. The categories may be determined based on one or more criteria, for example, the type of content provided by the content provider, topics described in the content provided by the content provider, one or more objects presented in the content of the content provider, a type of product or service offered by the content provider, terms and keywords associated with the content provider, and so on. If the online system 150 receives a request for a report based on viewability metric for a content provider for which there is insufficient viewability signal information, the online system 150 analyzes information describing the content provider to determine a category for the content provider and uses the correlation model for the determined category to predict the viewability metric for the content provider for generating the requested report.

In an embodiment, the online system 150 measures a level of correlation between the user interaction metric values and the viewability metric values for content items for which viewability signals are available. If the online system determines that the level of correlation between the user interaction metric values and the viewability metric values is below a threshold value, the online system does not generate a correlation model. For example, the online system returns an error indicating that the correlation model cannot be generated. In this embodiment, reports based on viewability signals may fail to generate or may be generated with incomplete viewability signals and provided with appropriate message indicating a warning that the report is based on insufficient data and may not be accurate or complete.

### Applications of Viewability Prediction

Predicted viewability signal is used in a variety of applications. These applications generate reports based on viewability signals. As one example, the predicted viewability signal can be used in generating reports for measuring online campaign results. For example, campaign results with viewability signals or without viewability signals are generated. The generated reports may provide comparison of content providers based on viewable impression level.

As another example, the predicted viewability signal is used in reach and frequency reports that provide information on a number of users that have viewed content items of content publishers and the number of times the users have seen the content items. Predicted viewability signals provide an accurate estimate of reach of online content. As a further example, the predicted viewability signal is used in accurate determination of multi touch attribution, which determines credit assignment of providers in attribution. As a further example, the predicted viewability signal can be used in cross content provider campaign insights and content provider scoring. The predicted viewability metrics can be used to score content providers before content providers launch campaigns.

### Additional Configuration Information

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
sending one or more content items for display via client devices;
receiving a request for a report based on viewability of the one or more content items, the viewability comprising a viewability metric representing a likelihood that a user viewed the one or more content items;
receiving user interactions associated with a content item;
determining a user interaction metric representing a rate of user interactions with the content item;
providing the value of the user interaction metric as input to a correlation model configured to receive an input value of the user interaction metric and predict a corresponding value of the viewability metric; and
predicting a value of the viewability metric for the one or more content items using the correlation model; and
generating the requested report based on the predicted value of the viewability metric.

2. The computer-implemented method of claim 1, further comprising:
sending a plurality of content items for display via client devices;
receiving user interactions and viewability signals associated with the plurality of content items;
determining values of user interaction metric and corresponding values of viewability metric based on the receiving user interactions and viewability signals; and
generating the correlation model based on the determined values of user interaction metric and corresponding values of viewability metric.

3. The computer-implemented method of claim 2, wherein generating the correlation model comprises curve fitting based on the determined values of user interaction metric and corresponding values of viewability metric.

4. The computer-implemented method of claim 2, wherein the correlation model is a polynomial function that maps values of user interaction metric to values of viewability metric.

5. The computer-implemented method of claim 2, wherein the correlation model is a linear function that maps values of user interaction metric to values of viewability metric.

6. The computer-implemented method of claim 1, wherein the user interaction metric represents a click through rate (CTR).

7. The computer-implemented method of claim 1, wherein the viewability metric is based on a size of a portion of a particular content item displayed on a display screen of the client device.

8. The computer-implemented method of claim 1, wherein the viewability metric is based on an amount of time that the content item was presented on a display screen of a particular client device.

9. The computer-implemented method of claim 1, wherein the correlation model is for a content provider, and wherein the one or more content items for generating the model are associated with the content provider.

10. The computer-implemented method of claim 1, wherein the correlation model is for a placement within a web page, and wherein the one or more content items for generating the model are associated with the placement on the web page.

11. The computer-implemented method of claim 1, wherein the generated report describes results of an online campaign for sending content items to users.

12. The computer-implemented method of claim 1, wherein the generated report ranks content distribution across content providers.

13. A non-transitory computer-readable medium storing instructions, wherein the stored instructions are for:
sending one or more content items for display via client devices;
receiving a request for a report based on viewability of the one or more content item, the viewability comprising a viewability metric representing a likelihood that a user viewed the content;
receiving user interactions associated with a content item;
determining a user interaction metric representing a rate of user interactions with the content item;
providing the value of the user interaction metric as input to a correlation model configured to receive an input value of the user interaction metric and predict a corresponding value of the viewability metric; and
predicting a value of the viewability metric for the one or more content items using the correlation model; and
generating the requested report based on the predicted value of the viewability metric.

14. The non-transitory computer-readable medium of claim 13, wherein the stored instructions further comprise instructions for:
sending a plurality of content items for display via client devices;
receiving user interactions and viewability signals associated with the plurality of content items;
determining values of user interaction metric and corresponding values of viewability metric based on the receiving user interactions and viewability signals; and
generating the correlation model based on the determined values of user interaction metric and corresponding values of viewability metric.

15. The non-transitory computer-readable medium of claim 14, wherein instructions for generating the correlation model comprise instructions for curve fitting based on the determined values of user interaction metric and corresponding values of viewability metric.

16. The non-transitory computer-readable medium of claim 13, wherein the correlation model is a polynomial function that maps values of user interaction metric to values of viewability metric.

17. The non-transitory computer-readable medium of claim 13, wherein the user interaction metric represents a click through rate (CTR).

18. The non-transitory computer-readable medium of claim 13, wherein the correlation model is for a content provider, and wherein the one or more content items for generating the model are associated with the content provider.

19. The non-transitory computer-readable medium of claim 13, wherein the correlation model is for a placement within a web page, and wherein the one or more content items for generating the model are associated with the placement on the web page.

20. A computer system comprising:
one or more computer processors; and
a non-transitory computer-readable medium storing instructions, wherein the stored instructions are for:
sending one or more content items for display via client devices;
receiving a request for a report based on viewability of the one or more content item, the viewability comprising a viewability metric representing a likelihood that a user viewed the content;
receiving user interactions associated with a content item;
determining a user interaction metric representing a rate of user interactions with the content item;
providing the value of the user interaction metric as input to a correlation model configured to receive an input value of the user interaction metric and predict a corresponding value of the viewability metric; and
predicting a value of the viewability metric for the one or more content items using the correlation model; and
generating the requested report based on the predicted value of the viewability metric.
